(19) United States
(12) Patent Application Publication
(10) Pub. No.: US 2007/0086062 A1
(43) Pub. Date: Apr. 19, 2007

(54) Image forming device having unified address book and method for transmitting scan-data thereof

(75) Inventor: Won-ho Song, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/529,395

(22) Filed: Sep. 29, 2006

(30) Foreign Application Priority Data
Oct. 18, 2005 (KR) 2005-98315

(51) Int. Cl. H04N 1/00

(52) U.S. Cl. 358/401; 358/1.15

(57) ABSTRACT

A image forming device having a unified address book and method for transmitting a scan-data thereof includes a scanning part to scan a document and create a scan-data, a storing part to store an address book including an address information of a recipient, an user interfacing part to display the stored address book and receive the address information to transmit the scan-data selected through the address book by the user, a controlling part to extract the address book from the storing part and to display the extracted address book on the user interfacing part, when the document to be scanned is recognized as being inserted into the scanning part, and control the scanning part to scan the inserted document, when the address information is received through the user interfacing part, and a data communicating part to transmit the scan-data created based on the received address information.

### CROSS-REFERENCE TO RELATED APPLICATIONS

This application claims the benefit of Korean Application No. 2005-98315, filed Oct. 18, 2005 in the Korean Intellectual Property Office, the disclosure of which is incorporated herein by reference.

### BACKGROUND OF THE INVENTION

1. Field of the Invention

Aspects of the present invention relate to an image forming device having a unified address book and method for transmitting a scan-data thereof. More particularly, aspects of the present invention relate to an image forming device having a unified address book and method for transmitting scan-data thereof, which provides convenient transmission of scan-data through the unified address book.

2. Description of the Related Art

Generally, various input and output devices are being used increasingly due to office automation. These include a laser beam printer, a LPH (LED Print Head) printer, a copier and a facsimile commonly referred to as an image forming device. A conventional image forming device has individual functions, such as printing or duplicating, independently existing in one device. A recently developed image forming device integrates various functions, such as printing, scanning and facsimileing into one device, and it is referred to as a Multi Function Printer (MFP).

The MFP has primary functions, such as a printing function of the printer and a scanning function of the scanner, and secondary functions of transmitting and receiving data through various communication modules.

The conventional image forming device has a small capacity of memory only enough to temporarily store data provided from a host device until the data is output. However, a recent image forming device has a large capacity storing medium equivalent to a Hard Disk Drive (HDD) of the host device. The image forming device with a large capacity storing medium is able to store various information in the image forming device, particularly, to fax through communication modules, and to store an address book in the storing medium for use in email-transmission.

A method for using an address book of the conventional image forming device will be described. When a user selects his or her desired function to use, for example fax or email, only information corresponding to the selected function out of the address book is provided to the user. That is, when the user wants to transmit the email using the image forming device, the image forming device provides the user with only an email address of the address book stored in the storing medium. Thus, the conventional image forming device is inconvenient because the user must manually specify input options for a recipient information and data for each use of the image forming device to transmit by fax or email.

### SUMMARY OF THE INVENTION

An aspect of the present invention is to address at least the above problems and/or disadvantages of the related art and to provide at least the advantages described below. Accordingly, an aspect of the present invention is to provide an image forming device having a unified address book and method for transmitting a scan-data thereof capable of easily setting a data transmission path through the unified address book displaying various transmission information or portions thereof on one screen.

In order to achieve the above-described aspects of the present invention, there is provided an image forming device having a unified address book having a scanning part to scan a document and to create a scan-data, a storing part to store an address book including an address information of a recipient, a user interfacing part to display the stored address book and to receive the address information to transmit the scan-data selected through the address book by the user, a controlling part to extract the address book from the storing part and to display the extracted address book on the user interfacing part, when the document to be scanned is recognized as being inserted into the scanning part, and controlling the scanning part to scan the inserted document, when the address information is received through the user interfacing part, and a data communicating part transmitting the scan-data created based on the received address information.

The controlling part may recognize the document to be scanned as being inserted in the scanning part, when one of insertion of the document to be scanned into an Auto Documents Feeder (ADF) of the scanning part and/or when a flatbed cover of the scanning part is opened.

The address information may include at least one of a telephone number, a fax number, an email address, File Transfer Protocol (FTP) address, or any combination thereof. A received data property may be applied in transmitting the scan-data.

The data communicating part may include a Public Switched Telephone Network (PSTN) interfacing part and a network interfacing part.

The image forming device having a unified address book may further include an embedded web server part capable of editing the address book.

The controlling part may control the image forming device to copy the document to be scanned, when the document to be scanned is recognized as being inserted into the scanning part, but a requesting signal to copy is received from the user interfacing part.

The controlling part may control the image forming device to copy the document to be scanned, when the document to be scanned is recognized as being inserted into the scanning part, but the address information is not received from the user interfacing part and a predetermined time passes.

A method for transmitting a scan-data of an image forming device, may include displaying an address book including an address information of a recipient, when a document to be scanned is inserted in a scanning part, receiving the address information to transmit scan-data selected through the address book by a user, creating the scan-data by scanning the document, and transmitting the scan-data based on the received address information.

The address information may include at least one of a telephone number, a fax number, an email address, and/or a File Transfer Protocol FTP address. A data property may be applied in transmitting the scan-data.

The method for transmitting a scan-data of an image forming device, may further include editing the address book using an embedded web server part.

The method for transmitting a scan-data of an image forming device, may further include copying the document to scan, when the document to be scanned is recognized as being inserted, but a requesting signal to copy is received from the user.

The method for transmitting a scan-data of an image forming device, may further include copying the document to scan, when the document to be scanned is recognized as being inserted, but the address information is not received from the user interfacing part and a predetermined time passes.

There is also provided an image forming device containing at least one address book, and having a storage to store the at least one address book containing a plurality of address information for at least one recipient, a user interface to display the plurality of address information and to receive a user's selection of the at least two of the address information, and a data communicator to transmit at least one scan-data to the selected at least two address information for the at least one recipient using at least one communication network.

A method of transmitting a scan-data of a document to a recipient using an address book of an image forming device, includes obtaining at least one scan-data, selecting at least two of a recipient's address information using an address book of an image forming device, and transmitting the at least one scan-data to the at least two address information using at least one communication network.

An image forming device having a unified address book, includes a storage to store the unified address book containing at least one address information for each recipient, a user interface to display the at least one address information and to receive a user's selection of the at least one address information, and a data communicator to transmit at least one scan-data to the selected at least one address information using a data transmission path corresponding to the selected at least one address information.

A method of transmitting a scan-data to a recipient using an image forming device containing an address book having at least one address information for each recipient, includes displaying the at least one address information, receiving a user's selection of the at least one address information, and transmitting the scan-data to the selected at least one address information using a data transmission path corresponding to the selected at least one address information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects of the present invention, taken in conjunction with the accompanying drawings of which:

FIG. 1 is a block diagram of an image forming device having a unified address book according to an aspect of the present invention,

FIG. 2 shows a layout of a user interfacing part of FIG. 1,

FIG. 3 is a diagram explaining an Embedded Web Server part (EWS part) of FIG. 1, and

FIG. 4 is a flowchart explaining a scan-data transmission method of an image forming device having a unified address book according an aspect of the present invention.

### DETAILED DESCRIPTION OF THE EMBODIMENTS

Reference will now be made in detail to the aspects of the present invention, examples of which are illustrated in the accompanying drawings, wherein like reference numerals refer to the like elements throughout. The aspects are described below in order to explain the present invention by referring to the figures.

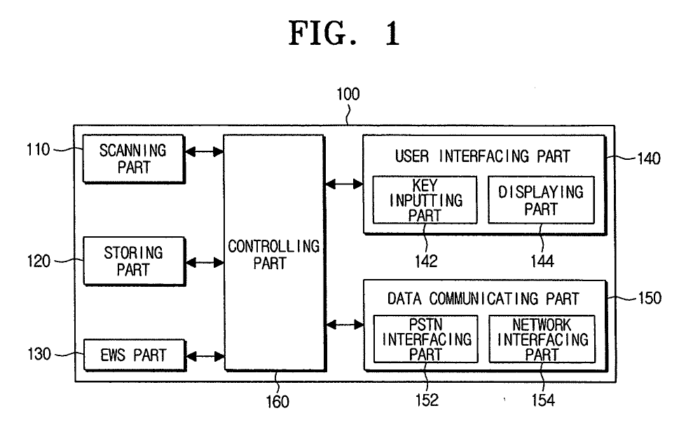

FIG. 1 is a block diagram of an image forming device having a unified address book according to an aspect of the present invention. Referring to FIG. 1, the image forming device 100 having a unified address book according to an aspect of the present invention includes a scanning part 110, a storing part 120, an Embedded Web Server part (EWS part) 130, a user interfacing part 140, a data communicating part 150, and a controlling part 160. It is understood that in other aspects of the present invention, one or more of the parts 110-160 may be combined and the functionalities of the parts 110-160 may be implemented by a few or a single part of the image forming device 100. It is also understood that the parts 110-160 may be implemented as software and/or firmware for use with one or more processors and/or computers.

The scanning part 110 creates scan-data by scanning a predetermined document. The scanning part 110 may scan each page of the documents supplied one by one as with a general flatbed type of scanner, or scan several pages of the document supplied at one time as with an Auto Documents Feeder (ADF). It is understood that several documents may be scanned at one time.

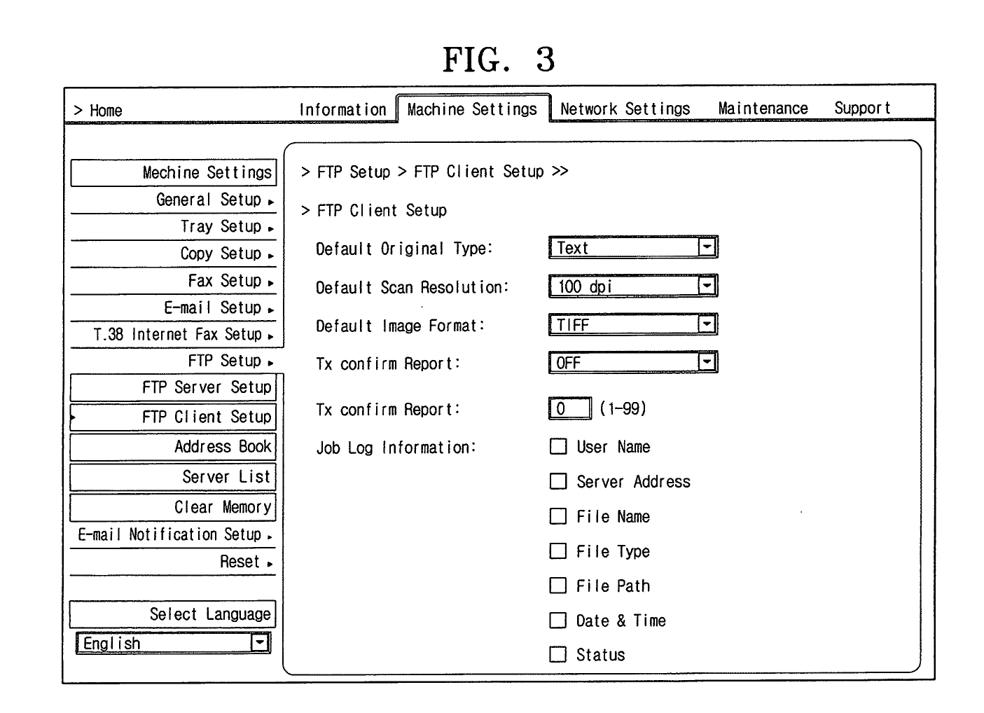

The storing part 120 stores an address book including at least one transmission information of a recipient. Transmission information include information usable to transmit data, such as scan-data, to a recipient. Transmission information include recipient address information that indicates a location where the recipient may receive the scan-data. Various non-limiting examples of transmission information may be at least one of a telephone number, a fax number, an email address, a File Transfer Protocol (FTP) address. In other words, a telephone number, a fax number, an email address, a File Transfer Protocol (FTP) address, or any combination thereof. Transmission information also include data properties of the data, such as scan-data, of the recipient. Non-limiting examples of the data properties are discussed below in the discussion of FIG. 3.

In other aspects of the present invention, the storing part 120 stores one or more address books containing one or more transmission information of one or more recipients. When one or more address books are stored, one of the address books may be designated as a primary address book and the remaining address books may be designated as secondary address books. One of the address books may be designated as the default address book to be displayed first. Hereinafter, use of the address book in singular term will include the case of one or more of the address books in plural term. Although not required in all aspects, examples of the storing part 120 may be an EEPROM, a complementary metal oxide semiconductor (CMOS), a FLASH memory, a hard disk, optical media, and/or magneto optical media, but are not limited thereto.

The EWS part 130 provides editing functions of the address book stored in the storing part 120. A user may use the editing functions such as inserting, deleting and/or adding the transmission information of the recipient through a User Interface (UI) provided by the EWS part 130, and set and change data properties of the scan-data to be transmitted to the recipient. It is understood that the editing functions of the UI provided by the EWS part 130 includes adding or deleting one or more of the recipients in the address book.

Although not required in all aspects, the EWS of the EWS part 130 is a software developed to be included in a small-sized network device which is less functional than a general web server part developed to be included in a general computer such as a personal computer or a work station. The EWS has simpler functions than the general web server part. Although not required in all aspects, the EWS is efficiently used in a small-sized environment in need of one to one management. The EWS is built in a printer (not shown) to set a control panel (or a layout) and confirms a state of the printer and/or a state of consumable items such as toner cartridges. In other aspects of the present invention, the general web server may be used to implement the EWS of the EWS part 130.

The UI provided by the EWS part 130 will be described in the description of FIG. 3 below. The interfacing part 140 supports interfacing between the user and the image forming device 100. The user interfacing part 140 includes a key inputting part 142 and a displaying part 144. According to an aspect of the present invention, the user interfacing part 140 includes the key inputting part 142 and the displaying part 144, but a function of the key inputting part 142 may be replaced by and/or may be included in the displaying part 144 in a touch screen form.

The displaying part 144 of the user interfacing part 140 is disposed on a front panel (not shown) of the image forming device 100, and displays the address book stored in the storing part 120 under the control of the controlling part 160, so that the user can recognize, view, and/or access the address book stored in the storing part 120.

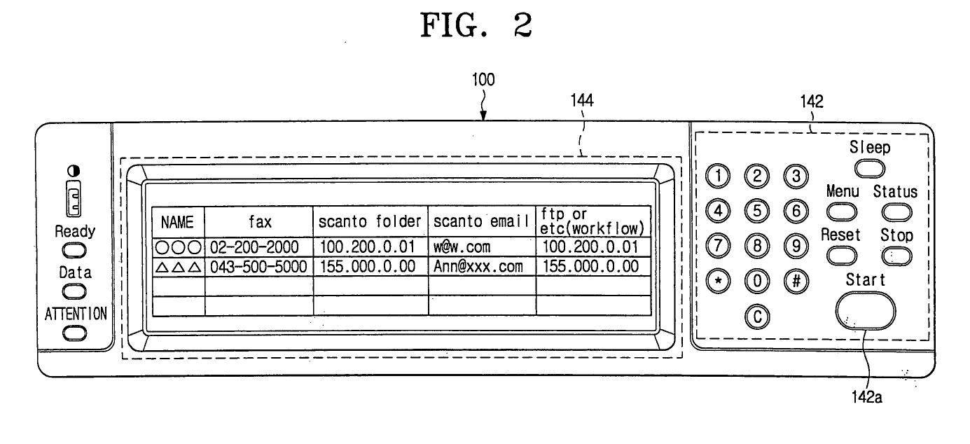

The key inputting part 142 of the user interfacing part 140 is disposed on the front panel of the image forming device 100 like the displaying part 144, and receives a predetermined request signal from the user. According to an aspect of the present invention, the key inputting part 142 receives transmission information of the scan-data the user selects using the address book displayed on the displaying part 144. The key inputting part 142 and the displaying part 144 disposed on the front panel of the image forming device 100 will be described below in detail in view of FIG. 2. The data communicating part 150 transmits the scan-data generated by the scanning part 110 using the transmission information received through the key inputting part 142 of the user interfacing part 140. The data communicating part 150 includes a Public Switched Telephone Network (PSTN) interfacing part 152 and/or a network interfacing part 154.

The PSTN interfacing part 152 supports interfacing between the image forming device 100 and a PSTN network (not shown). The image forming device 100 may fax the scan-data through the PSTN interfacing part 152 through the PSTN network. The network interfacing part 154 supports interfacing between the image forming device 100 and networks (not shown). The image forming device 100 may transmit the scan-data by email and/or FTP through the network interfacing part 152. In various aspects of the present invention, the networks are links that connect various users and/or recipients, and non-limiting examples of the networks include various links such as data links, telecommunication links, various networks such as data networks, telecommunication networks and include a global network such as the internet, and a local network such as an intranet, or various combination thereof, and any part may be wired and/or be wireless. It is understood that the PSTN network and communication networks are also examples of the networks. The networks are paths for transmission of the scan-data from the image forming device 100 to one or more recipients.

The controlling part 160 controls overall functions of the image forming device 100. The controlling part 160 controls signal input and output between the various parts, including the scanning part 110, the storing part 120, the EWS part 130, the user interfacing part 140, that is, between the key inputting part 142 and the displaying part 144, and/or the data communicating part 150, that is, between the PSTN interfacing part 152 and the network interfacing part 154.

When it is recognized that a document to be scanned is inserted in the scanning part 110, the controlling part 160 extracts the address book from the storing part 120 and controls the displaying part 144 to display the address book on the displaying part 144 of the user interfacing part 140. The controlling part 160 recognizes that the document to be scanned is inserted in the scanning part 110 when a flatbed cover of the scanning part 110 is open or the document to be scanned is inserted in the ADF. While not required in all aspects, the scan-data may simply be obtained from the storing part 120 and/or from another device, by fax, email, and/or from other external scanners through the one or more communication networks without requiring onsite scanning of the document to create the scan-data.

When it is recognized that the document to be scanned is inserted in the scanning part 110, but a requesting signal to copy the document is received through the key inputting part 142, or the transmission information is not received from the user interfacing part 140 and a predetermined time passes, the controlling part 160 controls the image forming device 100 to copy the document inserted in the scanning part 110. That is, the controlling part 160 controls the scanning part 110 to scan the document and the printing part (not shown) to output the scan-data.

When the transmission information is received through the key inputting part 142 of the user interfacing part 140, the controlling part 160 controls the data communicating part 150 connected with one or more communication networks corresponding to the received one or more transmission information, that is, the PSTN interfacing part 152 and/or the network interfacing part 154 to transmit the scan-data.

The controlling part 160 controls the data communicating part 150, that is, the PSTN interfacing part 152 and/or the network interfacing part 154 to transmit the scan-data by data properties preset and/or pre-selected through the EWS part 130. Although not required in all aspects, the data properties may be preset and/or pre-selected according one or more communication networks, one or more user, and/or one or more recipient.

FIG. 2 shows a layout of the user interfacing part of FIG. 1.

In aspects of the present invention, the key inputting part 142 and the displaying part 144 are disposed on the front panel (not shown) of the image forming device 100. The key inputting part 142 is provided with a plurality of function keys such as a number key, a menu key, and a start key 142a, etc., as shown.

When it is recognized that the document to be scanned is inserted in the scanning part 110, the controlling part 160 extracts the address book from the storing part 120 and controls the displaying part 144 to display the address book on the displaying part 144. Accordingly, the address book is displayed on the displaying part 144, as illustrated in FIG. 2.

The user, by use of the key inputting part 142, selects the transmission information corresponding to a recipient to transmit the scan-data using the address book displayed on the displaying part 144. For example, the user selects a fax number of the recipient “000,” when the user wishes to transmit a scan-data of a document to the recipient “000” by fax. Accordingly, the transmission information selected by the user from the key inputting part 142 that is the fax number of the recipient “000,” “02-200-2000” is received into the controlling part 160. If desired, the user can select an email address of the recipient “000,” when the user wishes to transmit the scan-data of the document to “000” by email. Accordingly, the transmission information selected by the user from the key inputting part 142 that is the email address of the recipient “000,”“w@ w.com” is received into the controlling part 160.

It is understood that the user can select both the fax number and the email address of the recipient “000” so that the scan-data may be transmitted to the recipient “000” by both fax and email. It is understood that any combination of the available transmission information may be selected to transmit the scan-data in one or more ways or paths. Although not required in all aspects, one of the transmission information can be designated as corresponding to one of several of data transmission paths. One of the data transmission paths may be designated as the default or primary path for transmission of the scan-data. Although not required in all aspects, the scan-data may be transmitted to several recipients by one or more data transmission paths.

While the address book is displayed on the displaying part 144, the user may selectively change the transmission information, such as by adding or deleting one or more entries of recipients, or adding or deleting one or more transmission information of one or more recipients and change the data properties. The changed transmission information may be applied to the scan-data transmission only on a one time basis, and not be stored in the storing part 120.

As discussed above, when the user inserts the document to be scanned in the scanning part 110, the address book is displayed on the displaying part 144. When the user pushes the start key 142a of the key inputting part 142 while not inputting the transmission information from the address book, the controlling part 160 controls the image forming apparatus 100 to copy the document inserted in the scanning part 110 and controls the outputting of the document scanned by the scanning part 110.

If the user does not input the transmission information from the address book and a predetermined time passes, while the document to be scanned is inserted in the scanning part 110 by the user and the address book is displayed on the displaying part 144, the controlling part 160 outputs the document scanned by the scanning part 110 as a copy of the document inserted in the scanning part 110.

FIG. 3 is a diagram explaining the Embedded Web Server part (EWS part) of FIG. 1. As discussed above, it is possible to edit the address book, set the control panel, and confirm and manage the printer and the consumable through the EWS part 130. In order to explain such operations, FIG. 3 shows an aspect of an UI provided through the EWS part 130.

As discussed above, the UI provided through the EWS part 130 is usable to set all the functions offered by the image forming device 100. According to the aspect of the present invention, it is possible to set and/or adjust a device setting, a general setting, a tray setting, a copy setting, a fax setting, an email setting, a T.38 Internet fax setting, an FTP setting, an FTP server part setting, FTP client setting, an address book setting, a server part list, a memory setting, or any combination thereof. The user may change each of the value settings through the UI provided through the EWS part 130. For example, it is possible to set data properties such as scan-data type, resolution, and/or image format related to the device setting.

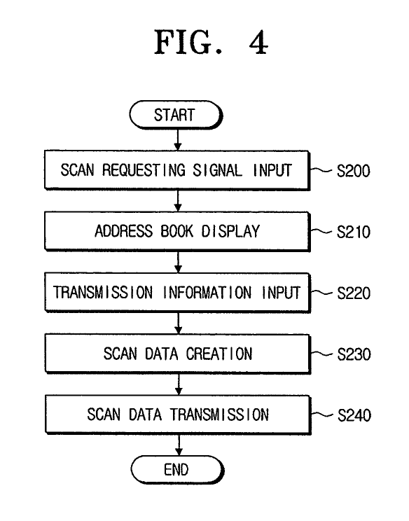

FIG. 4 is a flowchart explaining a scan-data transmission method of an image forming device having a unified address book according an aspect of the present invention. When transmitting the scan-data using the image forming device 100, the user inserts the document to be scanned in the scanning part 110. That is, the user opens the flatbed cover to insert the document, or insert the document in the ADF (operation S200). In other aspects of the present invention, the scan-data of the document may be obtained from the storing part 120 and/or from another device, by fax, email, and/or from other external scanners through the one or more communication networks, without requiring on-site creation of the scan-data.

If it is recognized that the document to be scanned is inserted in the scanning part 110, and/or otherwise obtained, the controlling part 160 extracts the address book stored in the storing part 120 and controls the displaying part 144 of the user interfacing part 140 to display the address book. Accordingly, as illustrated in FIG. 2, the displaying part 144 displays the address book where various transmission information are displayed on one screen (operation S210). If the address book is displayed on the displaying part 144, the user selects one or more transmission information to transmit the scan-data using the displayed address book. The one or more transmission information selected by the user from the key inputting part 142 is received into the controlling part 160 under the control of the user (operation S220).

When the transmission information selected by the user is input, the controlling part 160 controls the scanning part 110 to scan the document. The scanning part 110 scans the document and creates the scan-data of the document under the control of the controlling part 160 (operation S230).

When the scan-data is created by the scanning part 110, the controlling part 160 controls the data communicating part 150 corresponding to one or more of the transmission information received from the key inputting part 142 to transmit the scan-data. The PSTN interfacing part 152 and/or the network interfacing part 154 transmits the scan-data under the control of the controlling part 160 (operation S240). While not required in all aspects of the present invention, the scan-data may be transmitted to a two or more of a recipient's transmission information, either simultaneously, or sequentially, and may be transmitted to two or more recipients.

While not required in all aspects, all or some of the elements of the method can be implemented as software and/or firmware for use with one or more processors and/or computers. Moreover a processor and/or computer readable medium maybe encoded with computer and/or processor-executable instructions for performing the method.

In the above process, the user may easily transmit the scan-data on the document by use of his or her desired communicating networks.

As discussed above, the image forming device having the unified address book and method for transmitting the scan-data thereof may set a data transmission path and data properties through the unified address book having various transmission information unified in one address book, and accordingly the user's convenience is enhanced.

Although a few aspects of the present invention have been shown and described, it would be appreciated by those skilled in the art that changes may be made in these aspects without departing from the principles and spirit of the invention, the scope of which is defined in the claims and their equivalents.

What is claimed is:

1. An image forming device having a unified address book, comprising:
a scanning part to scan a document and to create a scan-data of the document;
a storing part to store an address book including an address information of a recipient;
a user interfacing part to display the stored address book and to receive the address information to transmit the scan-data selected through the address book by a user;
a controlling part to extract the address book from the storing part and to display the extracted address book on the user interfacing part when the document to be scanned is recognized as being inserted into the scanning part, and to control the scanning part to scan the inserted document when the address information is received through the user interfacing part; and
a data communicating part to transmit the scan-data created based on the received address information.

2. The image forming device of claim 1, wherein the controlling part recognizes the document to be scanned as being inserted into the scanning part when one of the document to be scanned is inserted into an Auto Documents Feeder (ADF) of the scanning part and/or when a flatbed cover of the scanning part is opened.

3. The image forming device of claim 1, wherein the address information comprises at least one of a telephone number, a fax number, an email address, and a File Transfer Protocol (FTP) address.

4. The image forming device of claim 1, wherein the user interfacing part further receives a data property to be applied in transmitting the scan-data.

5. The image forming device of claim 1, wherein the data communicating part comprises a Public Switched Telephone Network (PSTN) interfacing part and/or a network interfacing part.

6. The image forming device of claim 1, further comprising:
an embedded web server part capable of editing the address book.

7. The image forming device of claim 1, wherein the controlling part controls the image forming device to copy the document to be scanned, when the document to be scanned is recognized as being inserted into the scanning part, but a requesting signal to copy is received from the user interfacing part.

8. The image forming device of claim 1, wherein the controlling part controls the image forming device to copy the document to be scanned, when the document to be scanned is recognized as being inserted into the scanning part, but the address information is not received from the user interfacing part and a predetermined time passes.

9. A method for transmitting a scan-data of an image forming device, comprising:
displaying an address book including an address information of a recipient, when a document to be scanned is inserted in a scanning part;
receiving the address information to transmit a scan-data selected through the address book by a user;
creating the scan-data by scanning the document; and
transmitting the scan-data based on the received address information.

10. The method for transmitting a scan-data of claim 9, wherein the address information comprises at least one of a telephone number, a fax number, an email address, and a File Transfer Protocol (FTP) address.

11. The method for transmitting a scan-data of claim 9, wherein the receiving step further comprises receiving a data property to be applied in transmitting the scan-data.

12. The method for transmitting a scan-data of claim 9, further comprising editing the address book using an embedded web server part.

13. The method for transmitting a scan-data of claim 9, further comprising:
copying the document to be scanned, when the document to be scanned is recognized as being inserted into a scanning part, but a requesting signal to copy is received from the user.

14. The method for transmitting a scan-data of claim 9, further comprising:
copying the document to be scanned, when the document to be scanned is recognized as being inserted into a scanning part, but the address information is not received from the user interfacing part and a predetermined time passes.

15. The image forming device of claim 1, wherein the scan-data is transmitted to two or more of the recipient's address information.

16. The image forming device of claim 4, wherein the data property includes at least one of a scan-data type, a resolution, and/or an image format related to the image forming device setting.

17. The method of claim 9, wherein the scan-data is transmitted to two or more of the recipient's address information.

18. The method of claim 11, wherein the data property includes at least one of a scan-data type, a resolution, and an image format related to the image forming device setting.

19. An image forming device containing at least one address book, comprising:
a storage to store the at least one address book containing a plurality of address information for at least one recipient;
a user interface to display the plurality of address information and to receive a user's selection of at least two of the address information; and
a data communicator to transmit at least one scan-data to the selected at least two address information for at least one recipient using at least one communication network.

20. The image forming device of claim 19, further comprising a scan data obtainer to obtain the scan-data.

21. The image forming device of claim 19, wherein the at least two address information includes at least two selected from a group that includes a telephone number, a fax number, an email address, and a File Transfer Protocol (FTP) address.

22. The image forming device of claim 1, wherein the at least one communication network includes at least one selected from a group that includes a Public Switched Telephone Network (PSTN), the internet, and/or an intranet.

23. A method of transmitting a scan-data to a recipient using an address book of an image forming device, comprising:
obtaining at least one scan-data;
selecting at least two of a recipient's address information using an address book of an image forming device; and
transmitting the at least one scan-data to the at least two address information using at least one communication network.

24. The method of claim 23, wherein the at least two address information includes at least two selected from a group that includes a telephone number, a fax number, an email address, and a File Transfer Protocol (FTP) address.

25. The method of claim 23, wherein the at least one communication network includes at least one selected from a group that includes a Public Switched Telephone Network (PSTN), the internet, and an intranet.

26. An image forming device having a unified address book, comprising:
a storage to store the unified address book containing at least one address information for each recipient;
a user interface to display the at least one address information and to receive a user's selection of the at least one address information; and
a data communicator to transmit at least one scan-data to the selected at least one address information using a data transmission path corresponding to the selected at least one address information.

27. The image forming device of claim 26, wherein the data transmission path includes at least one selected from a group that includes a Public Switched Telephone Network (PSTN), the internet, and an intranet.

28. The image forming device of claim 27, wherein the at least one address information includes at least one selected from a group that includes a telephone number, a fax number, an email address, and a File Transfer Protocol (FTP) address.

29. A method of transmitting a scan-data to a recipient using an image forming device containing an address book having at least one address information for each recipient, comprising:
displaying the at least one address information;
receiving a user's selection of the at least one address information; and
transmitting the scan-data to the selected at least one address information using a data transmission path corresponding to the selected at least one address information.

30. The method of claim 29, wherein the data transmission path includes at least one selected from a group that includes a Public Switched Telephone Network (PSTN), the internet, and an intranet.

31. The method of claim 30, wherein the at least one address information includes at least one selected from a group that includes a telephone number, a fax number, an email address, and a File Transfer Protocol (FTP) address.

32. A processor and/or a computer readable medium encoded with processor and/or computer-executable instructions for performing the method of claim 9.

33. A processor and/or a computer readable medium encoded with processor and/or computer-executable instructions for performing the method of claim 23.

34. A processor and/or a computer readable medium encoded with processor and/or computer-executable instructions for performing the method of claim 29.
